(19) United States
(12) Patent Application Publication
(10) Pub. No.: US 2015/0234105 A1
(43) Pub. Date: Aug. 20, 2015

(54) SYSTEM THAT CAN BE USED TO POLARISE GLASS, ACRYLIC AND SIMILAR AUTOMATICALLY AS REQUIRED BY THE USER

(71) Applicant: Eduardo Andres LARRAIN SANCHEZ, (US)

(72) Inventor: Eduardo Andres Larrain Sanchez, Santiago (CL)

(21) Appl. No.: 14/410,080

(22) PCT Filed: Jul. 3, 2013
(86) PCT No.: PCT/CL2013/000039

§ 371 Date: May 4, 2015

(30) Foreign Application Priority Data
Jun. 29, 2012 (AR) 20120102341

(51) Int. Cl. G02B 5/30; B60J 3/06; B60J 1/20; G02B 1/14; G02B 1/08; B60J 3/04; G02F 1/01; G02B 27/28

(52) U.S. Cl. CPC G02B 5/3033; G02F 1/0136; B60J 3/06; G02B 27/281; G02B 1/14; G02B 1/08; B60J 3/04; B60J 1/2094

(57) ABSTRACT

The invention relates to a system that can be used to polarize glass, acrylic and similar automatically as required by the user. The system is of the type used in all types of motor vehicles and buildings both to increase resistance and to obstruct the view of third persons and reduce the passage of light. The system is characterised in that the following elements are placed against or affixed to the glass or similar material, namely: a sheet containing graphene or a similar material connected by means of positive and negative cables to an electrical system and a transparent colour film that is not electrically connected. An electronic intensity-control regulator is disposed between the electricity source and the sheet of graphene or similar material. The user can adapt the glass, acrylic or similar material as desired or as required in order to obtain a darker colour. Depending on the intensity of the current applied using a switch it is possible to regulate the intensity, varying from light-dark to complete darkness while still being transparent, allowing polarization. The glass is hardened in the system, such that it is shock and impact resistant.

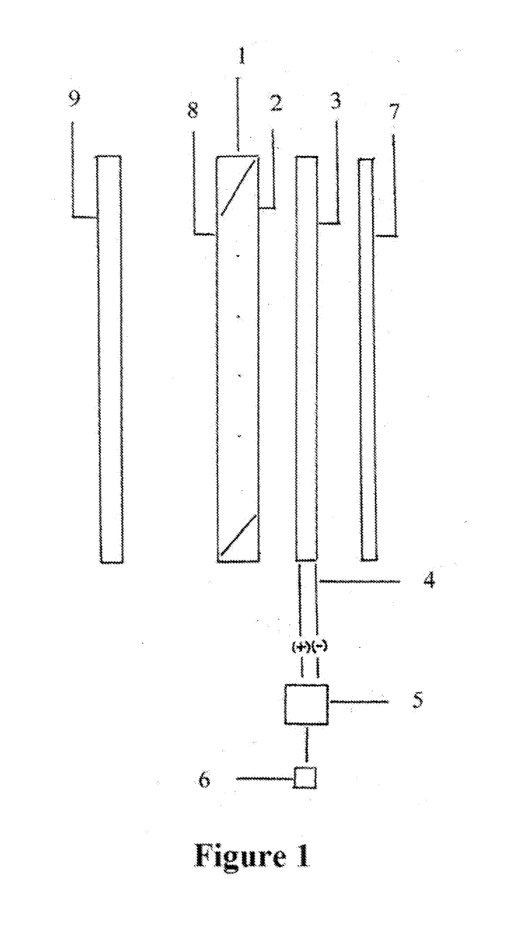

System that can be used to polarize glass, acrylic and similar material automatically as required by the user.

Through this procedure, we expressly request the registration of a creation in our country as well as abroad as a patent. The creation is completely and absolutely new and its main goal is a System that enables the polarization of glass, acrylic and similar material automatically as required by the user.

It is increasingly necessary to make improvements in the present condition of glass, acrylic or similar material that is used in houses, motor vehicles or other places. It is necessary for some of these elements to be able to improve the obstruction of vision through them and similarly, it is also necessary for these elements to offer more resistance against shocks arising from violence, theft or natural accidents.

The story is similar at houses, businesses, offices and other buildings. But in this case, apart from glass, it is possible to use acrylic and/or similar transparent materials either in windows or in galleries such as skylights or translucent roofs. Since ancient times, glass, or any transparent material, has been used in houses and buildings to enhance the visual space, thus providing an outside view, improving the architectural appearance, preventing the heat from escaping through the openings, enabling natural light to enter and illuminate the environment.

But in exchange for those advantages, the occupants and equipment are affected by various factors. For example, by the sunlight, which, by passing through these filterless transparent covers, generates heat and ultraviolet radiation and also by the thefts committed with the help of broken glass or similar material with acrylic.

The sunlight penetrates mercilessly into the surroundings, increases the temperature, damages and destroys the furniture, paintings, ornaments and upholstery.

But although curtains, shutters or awnings can dampen or slightly reduce the severity of the damages caused by the light, they do not provide a solution. Due to this reason, glass or acrylic or similar material is placed against solar control films, which offer some benefits, but also present problems.

The technology has spread to other films or mirror sheets, which have the ability to achieve a rebound effect of light. Their main feature is that they offer a greater thermal and visual insulation. They were designed to reject and rebound the sunlight, provide greater comfort, and save energy, among other advantages, not to mention the privacy.

Similar effects are also sought through the use of frosted sheets or films and the well-known blackouts. Their main feature is the visual control. They are translucent, but not transparent. Thus, they enable the passage of light, but obstruct the vision through them. They offer the possibility of covering the glass, acrylic or similar material completely or partially to achieve the required privacy or visual control.

But all these cases have drawbacks. One, the effects of the sheet are irreversible once it has been placed on the transparent element. So much so that if the translucent element receives a mirrored application, the translucent material shall be permanently affected.

As long as that cover is not removed and if it is toned with a darker color, it will be the new color of the translucent material.

The same will happen if the glass or transparent material is placed against a sheet that reproduces the frosting effects. Due to this the glass will lose its transparency to a large extent, as long as it has that sheet attached to it. But as explained later, this patent seeks protection for an invention that has created a system that enables the polarization of glass, acrylic and similar materials automatically to meet the needs of the user. It is a completely new invention that has led to a vital advancement in the technology of darkening and the safely of glass, acrylic or Similar material, for use in houses, motor vehicles, various objects, publicity posters, etc.

For all these elements, the solution proposed in this patent request is the same. It is concerned with applying a thin sheet containing graphene to the transparent element.

Grapheme is a mineral of extraordinary hardness, it can be therefore mentioned that glass, acrylic or similar material that is covered with it would be almost indestructible.

Therefore, applying a transparent plastic cover with graphene sticking to the glass, acrylic or similar transparent elements (of houses or cars or anything else whatsoever) and through the side overlooking the exterior makes them almost indestructible, both practically and economically.

If the graphene is on the outside of the glass, any amount of aggression against them would not be able to shatter them.

This is what it does to the outside of the glass as regards improving its hardness and resistance to aggression.

With respect to the darkening of vision through the glass or acrylic or similar material, the invention proposes to paste a plastic sheet to it, but to the inner side which has a graphene or similar material sticking to it, which would receive a weak electrical current from the connectors that make a mass on the sheet and temporarily on graphene and on the other hand, on the electrical system of the vehicle or the building, as the case may be.

Due to the electrical stimulus, graphene shall undergo a change in appearance and its translucent color would become dark or black wherein different shades of gray color may be manifested. Thus, a selective shade that would be able to change according to the needs would be obtained, but one that would preserve its transparency in other words, it would not lose its ability to enable a dim vision through the sheet and therefore, through the transparent material.

We give an example of its use in motor vehicles. If each glass has a sheet of this type attached to its inner side, it is connected by its own regulator. The back glass may show a clear grayish color, and the front glass or the glass on the right side (in need of more protection due to receiving the sun at that time) may become a lot darker than the rest.

Presently there is no case of application of graphene to a glass, either for making it indestructible or so that it may temporarily tone down through the stimulus of an electric current. The uses know no end.

We'll cite an interesting proposal as an example. Until the time the glazed skylights of factories, study rooms, laboratories, etc. tone down the passage of sunlight through sliding canvases or awnings, which burn and deteriorate with the passage of time, if the invention proposed herein is used in the glass, the glass would darken just by turning an electrical knob thereby enabling the passage of only the desired brightness. The color disappears when the knob is moved to the reverse side, which creates an initially colorless transparency.

The same would happen with the glass used in cars. By just moving an electrical knob from colorless transparent it would turn to darkened glass with any tone from clear gray to black.

On passing electricity through this material, it gradually changes its color from translucent to black.

As a plane graphene is empty inside each of the millions of ceils that it is made up of, it can indicate that the darkening obtained by passing the power does not prevent the vision through the plane, and through all those millions of free or empty graphene places.

To add to these advantages, when the electric current reaches the graphene plane (controlled by a voltage regulator) its color intensity varies from gray to black. In practice, a shaded and appropriate change of needs is achieved. Optional. Let's take an example of the use of the glass in motor vehicles. If each glass had its own regulator and was covered with graphene, it would have been possible to get the back glass to show a more marked grayish color than the front glass. And the glass on the right (in need of more protection due to receiving the sun at that time) can be made darker than that on the other side.

Based on the explanations given above, the example of the preferred execution proposes that a GRAPHENE SHEET (3) that, through one of its ends, will be connected through both positive and negative WIRES (4) that, through its other end, will, on their part, be connected to a DIMMER (5) and finally to a REGULATOR WITH A KNOB (5) which may as well be a remote controlled regulator, is applied by pasting, through electrostatic bonding or any other method to the SURFACE OF A TRANSPARENT MATERIAL (1) that may be glass, acrylic or similar material and its OUTER SIDE (2).

This type of invention also foresees that the SURFACE OF THE TRANSPARENT MATERIAL (1) can, through the opposite side or the INNER SIDE (8), have another GRAPHENE SHEET (9) pasted to it, besides a TRANSPARENT COLORED FILM (7) but without any power connections.

1. A system that enables the polarization of glass, acrylic and other similar materials of the type that is used in all type of motor vehicles and buildings for both increasing their resistance and obstructing the view of third persons besides reducing the passage of light characterized by placing it against or affixing it to a glass or similar material, a sheet containing graphene or similar material connected by means of positive and negative cables to an electrical system, wherein the grapheme layer is based on the second colored layer whose color changes from light-dark to black according to the intensity of the current.

2. A system that enables the polarization of glass, acrylic and other similar materials of the type that is used in all type of motor vehicles and buildings for both increasing their resistance and obstructing the view of third persons besides reducing the passage of light which INCLUDES adapting the glass, acrylic or similar material to the needs of the user so that it becomes darker and finally perfectly black.

3. A system that enables the polarization of glass, acrylic and other similar materials of the type that is used in all type of motor vehicles and buildings for both increasing their resistance and obstructing the view of third persons besides reducing the passage of light CHARACTERIZED BY placing it against or affixing it to the glass or similar material, a sheet containing graphene or similar material.

4 The system as claimed in claim 1, wherein includes the technical procedure for obtaining the black color, and the layer number 7 that deals with black color will be a plane electrode surface with silicon microspheres, and the silicon microspheres are injected with a transparent polymer and are thereby positioned, said silicon microspheres are covered and the acid is injected into them to dissolve the microspheres, thus replacing them with air bags that are found within the transparent polymer, which would later be filled up with electrolytes so as to ensure that they remain sealed.

5 The system as claimed in claim 1, wherein includes the information about the change from light-dark to black being approximately a second after the execution of electric current.

6 The system as claimed in claim 1, wherein includes the explanation of the implementation of color, said polarized glass or similar material being implemented in black color.

7 The system as claimed in claim 1, wherein includes clarifying the purpose and defining the change of sequence from light-dark to black, said system enabling the polarization of glass or similar material in the tone of dark colors as required by the user.
